(19) United States
(12) Patent Application Publication
(10) Pub. No.: US 2022/0171065 A1
(43) Pub. Date: Jun. 2, 2022

(54) SYSTEMS AND METHODS FOR PREDICTING A PEDESTRIAN MOVEMENT TRAJECTORY

(71) Applicant: BEIJING VOYAGER TECHNOLOGY CO., LTD., Beijing (CN)

(72) Inventors: Pei LI, Beijing (CN); You LI, Beijing (CN); Jian GUAN, Beijing (CN)

(73) Assignee: BEIJING VOYAGER TECHNOLOGY CO., LTD., Beijing (CN)

(21) Appl. No.: 17/674,799

(22) Filed: Feb. 17, 2022

Related U.S. Application Data
(63) Continuation of application No. PCT/CN2019/109352, filed on Sep. 30, 2019.

(51) Int. Cl. G01S 17/89; G01S 17/66; G01S 17/931; G01S 7/4865

(52) U.S. Cl. CPC G01S 17/89; G01S 7/4865; G01S 17/931; G01S 17/66

(57) ABSTRACT

Embodiments of the disclosure provide methods and systems for predicting a movement trajectory of a pedestrian. The system includes a communication interface configured to receive a map of an area in which the pedestrian is traveling and sensor data acquired associated with the pedestrian. The system includes at least one processor configured to position the pedestrian in the map, and extract pedestrian features from the sensor data. The at least one processor is further configured to identify one or more objects surrounding the pedestrian based on the positioning of the pedestrian, and extract object features of the one or more objects from the sensor data. The at least one processor is also configured to predict the movement trajectory and a movement speed of the pedestrian based on the extracted pedestrian features and object features using a learning model.

### CROSS REFERENCE TO RELATED APPLICATIONS

This application is a bypass continuation to PCT Application No. PCT/CN2019/109352, filed Sep. 30, 2019. The present application is also related to PCT Application Nos. PCT/CN2019/109350, PCT/CN2019/109354, and PCT/CN2019/109351, each filed Sep. 30, 2019. The entire contents of all of the above-identified applications are incorporated herein by reference in their entireties.

### TECHNICAL FIELD

The present disclosure relates to systems and methods for predicting a pedestrian movement trajectory and movement speed, and more particularly, to systems and methods for predicting a pedestrian movement trajectory and movement speed using features extracted from map and sensor data.

### BACKGROUND

Vehicles share roads with other vehicles, bicycles, pedestrians, and objects, such as traffic signs, road blocks, fences, etc. Therefore, drivers need to constantly adjust driving to avoid colliding the vehicle with such obstacles. While some obstacles are generally static and therefore easy to avoid, some others might be moving. For a moving obstacle, the driver has to not only observe its current position but to predict its moving trajectory in order to determine its future positions. For example, a pedestrian near the vehicle may go across the road in front of the vehicle, go in a direction parallel to the vehicle's driving direction, or make a stop. The driver typically makes the prediction based on observations such as the pedestrian's traveling speed, the direction the pedestrian is facing, and any hand signals the pedestrian provides, etc.

Automatous driving vehicles need to make similar decisions to avoid obstacles. Therefore, automatous driving technology relies heavily on automated prediction of the trajectories of other moving obstacles. However, existing prediction systems and methods are limited by the vehicle's ability to “see” (e.g., to collect relevant data), ability to process the data, and ability to make accurate predictions based on the data. Accordingly, automatous driving vehicles can benefit from improvements to the existing prediction systems and methods.

Embodiments of the disclosure improve the existing prediction systems and methods in automatous driving by providing systems and methods for predicting a pedestrian movement trajectory and movement speed using features extracted from map and sensor data.

### SUMMARY

Embodiments of the disclosure provide a system for predicting a movement trajectory of a pedestrian. The system includes a communication interface configured to receive a map of an area in which the pedestrian is traveling and sensor data acquired associated with the pedestrian. The system includes at least one processor configured to position the pedestrian in the map, and extract pedestrian features from the sensor data. The at least one processor is further configured to identify one or more objects surrounding the pedestrian based on the positioning of the pedestrian, and extract object features of the one or more objects from the sensor data. The at least one processor is also configured to predict the movement trajectory and a movement speed of the pedestrian based on the extracted pedestrian features and object features using a learning model.

Embodiments of the disclosure also provide a method for predicting a movement trajectory of a pedestrian. The method includes receiving, by a communication interface, a map of an area in which the pedestrian is traveling and sensor data acquired associated with the pedestrian. The method further includes positioning the pedestrian in the map and extracting pedestrian features from the sensor data, by at least one processor. The method also includes identifying one or more objects surrounding the pedestrian based on the positioning of the pedestrian; and extracting object features of the one or more objects from the sensor data, by the at least one processor. The method additionally includes predicting, by the at least one processor, the movement trajectory and a movement speed of the pedestrian based on the extracted pedestrian features and object features using a learning model.

Embodiments of the disclosure further provide a non-transitory computer-readable medium having instructions stored thereon that, when executed by at least one processor, causes the at least one processor to perform operations. The operations include receiving a map of an area in which the pedestrian is traveling and sensor data acquired associated with the pedestrian. The operations further include positioning the pedestrian in the map and extracting pedestrian features from the sensor data. The operations also include identifying one or more objects surrounding the pedestrian based on the positioning of the pedestrian; and extracting object features of the one or more objects from the sensor data. The operations additionally include predicting the movement trajectory and a movement speed of the pedestrian based on the extracted pedestrian features and object features using a learning model.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary road segment including a sidewalk next to vehicle lanes and a crosswalk, according to embodiments of the disclosure.

FIG. 2 illustrates a schematic diagram of an exemplary system for predicting a pedestrian movement trajectory, according to embodiments of the disclosure.

FIG. 3 illustrates an exemplary vehicle with sensors equipped thereon, according to embodiments of the disclosure.

FIG. 4 is a block diagram of an exemplary server for predicting a pedestrian movement trajectory, according to embodiments of the disclosure.

FIG. 5 is a flowchart of an exemplary method for predicting a pedestrian movement trajectory, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

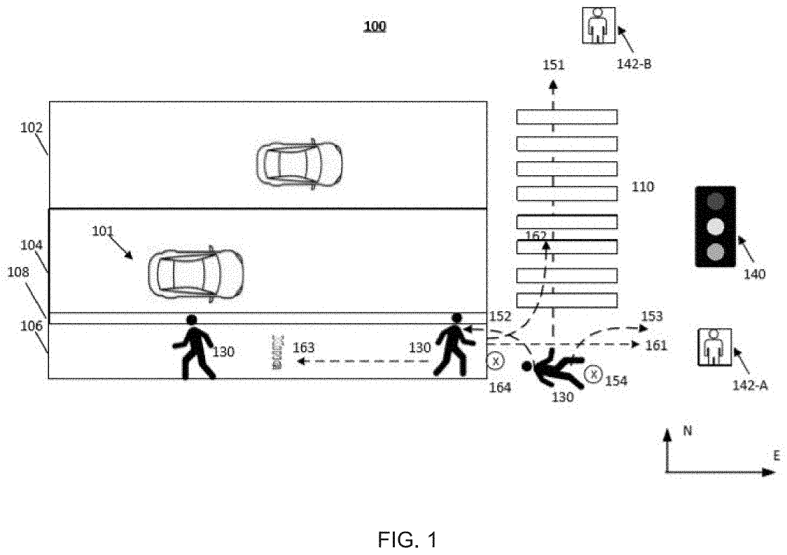

FIG. 1 illustrates a schematic diagram of an exemplary road segment 100 including a sidewalk 106 next to vehicle lanes 102 and 104 and a crosswalk 110, according to embodiments of the disclosure. As shown in FIG. 1, road segment 100 extends east-bound, facing traffic light 140 at a crossing. It is contemplated that road segment 100 can extend in any other directions, and is not necessarily adjacent to a traffic light.

Road segment 100 may be a part of a one-way or two-way road. For purpose of description, only two vehicle lanes in a single direction is shown in FIG. 1. However, it is contemplated that road segment 100 may include more or less vehicle lanes, and the vehicle lanes can be in both directions opposite to each other and separated by a divider. As shown in FIG. 1, road segment 100 includes vehicle lanes 102 and 104, and a sidewalk 106 to the right of vehicle lane 104. In some embodiments, sidewalk 106 may be separated from vehicle lane 104 by a divider 108, such as a guardrail, a fence, trees or bushes, or a no-entry zone. In some embodiments, sidewalk 106 may not be separated from vehicle lane 104, or separated only by a line marking.

Various vehicles may be traveling on vehicle lanes 102 and 104. For example, vehicle 101 may be traveling east-bound on vehicle lane 104. In some embodiments, vehicle 101 may be an electric vehicle, a fuel cell vehicle, a hybrid vehicle, or a conventional internal combustion engine vehicle. In some embodiments, vehicle 101 may be an autonomous or semi-autonomous vehicle.

Pedestrians may be traveling in one direction or both directions on sidewalk 106. For example, pedestrian 130 may be traveling east-bound or west-bound on sidewalk 106. In some embodiments, sidewalk 106 may be marked with a lane marking to indicate it is a sidewalk. For example, the word “Xing” may be marked on sidewalk 106, as shown in FIG. 1. In another example, a pedestrian icon alternative or in additional to the words may be marked on sidewalk 106.

Traffic of vehicles and pedestrians on road segment 100 may be regulated by traffic light 140 and pedestrian traffic lights 142 (e.g., including pedestrian traffic lights 142-A and 142-B). For example, traffic light 140 may regulate the vehicle traffic and pedestrian traffic lights 142 may regulate the pedestrian traffic. In some embodiments, traffic light 140 may include lights in three colors: red, yellow and green, to signal the right of way at the cross-road. In some embodiments, traffic light 140 may additionally include turn protection lights to regulate the left, right, and/or U-turns. For example, a left turn protection light may allow vehicles in certain lanes (usually the left-most lane) to turn left without having to yield to vehicles traveling straight in the opposite direction.

Pedestrian traffic lights 142-A and 142-B may be located at different corners of the cross-road, facing pedestrian traffic in respective directions. For example, pedestrian traffic light 142-A may face east-bound pedestrian traffic and pedestrian traffic light 142-B may face north-bound pedestrian traffic. A pedestrian traffic light may switch between two modes: a “walk” mode and “do not walk” mode. Depending on the design, the pedestrian traffic light may show different words or icons to indicate the modes. For example, the pedestrian traffic light may show a pedestrian icon when pedestrians and pedestrians are allowed to cross, and a hand icon to stop the same traffic. In some embodiments, pedestrian traffic lights 142 may additionally use different colors, sounds (e.g., beeping sounds), and/or flashing to indicate the modes. For example, the “walk” mode may be displayed in green and the “do not walk” mode may be displayed in red.

In some embodiments, pedestrian 130 may cross the road on a crosswalk 110. In some embodiments, crosswalk 110 may be marked using white stripes on the road surface (known as zebra lines). The traffic direction of a crosswalk extends perpendicularly to the stripes. For example, crosswalk 110 contains stripes extending east-west direction and pedestrian 130 walks north-bound or south-bound on crosswalk 110 to cross the road. A pedestrian walking on a crosswalk has the right of way and other traffics will stop and yield to the pedestrian until he has crossed. Although FIG. 1 shows only one crosswalk 110, it is contemplated that there may be additional crosswalks extending different directions. It is also contemplated that crosswalk 110 is not necessary located at a cross-road with traffic lights. In some embodiments, crosswalks may present in the middle of a road segment.

It is also contemplated that pedestrian 130 may routinely cross at places that are not regulated by traffic lights and/or have no crosswalk. For example, pedestrian 130 may cross the road in order to enter a trail on the other side of the road. In that case, the pedestrian may sometimes make a hand signal to the vehicles before getting into a vehicle lane. For example, the pedestrian may raise his palm to signal the vehicles to stop or point to the direction he intends to walk.

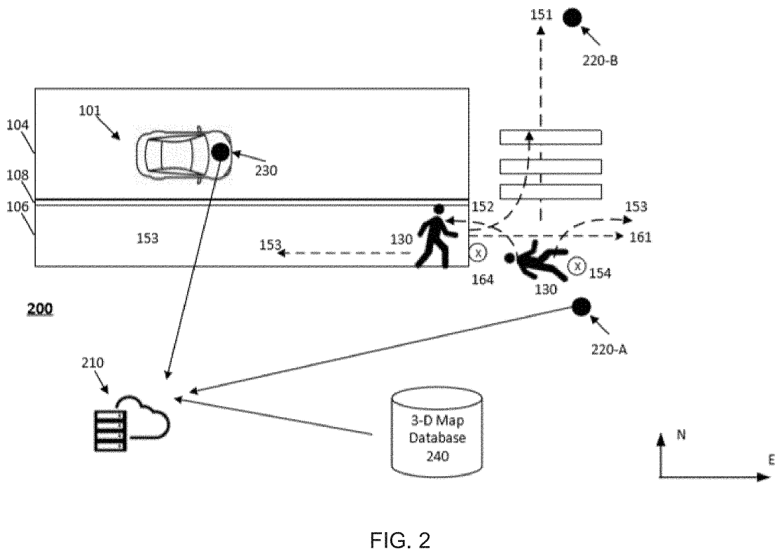

In some embodiments, vehicle 101 may be equipped with or in communication with a pedestrian trajectory prediction system (e.g., a system 200 shown in FIG. 2) to predict the movement trajectory of a pedestrian, such as pedestrian 130, in order to make decisions to avoid that pedestrian in its own travel path. For example, in the setting of FIG. 1, pedestrian 130 facing north may possibly follow four candidate trajectories: a candidate trajectory 151 to cross the road north-bound, a candidate trajectory 152 to turn left and go west-bound, a candidate trajectory 153 to turn right and go east-bound, and a candidate trajectory 154 to make a stop.

Consistent with embodiments of the present disclosure, the pedestrian trajectory prediction system may make “observations” (e.g., through various sensors) of pedestrian 130 and the surrounding objects, such as traffic light 140, pedestrian traffic lights 142, crosswalk 110, and any traffic sign along road segment 100. The pedestrian trajectory prediction system then makes a prediction which candidate trajectory pedestrian 130 may likely follow based on these observations. In some embodiments, the prediction may be preformed using a learning model, such as a neural network. In some embodiments, scores (e.g., probabilities and rankings) may be determined for the respective candidate trajectories 151-154 or 161-164.

FIG. 2 illustrates a schematic diagram of an exemplary system 200 for predicting a pedestrian movement trajectory, according to embodiments of the disclosure. In some embodiments, system 200 may include a pedestrian trajectory prediction server 210 (also referred to as server 210 for simplicity). Server 210 can be a general-purpose server configured or programmed to predict pedestrian movement trajectories or a proprietary device specially designed for predicting pedestrian movement trajectories. It is contemplated that server 210 can be a stand-alone server or an integrated component of a stand-alone server. In some embodiments, server 210 may be integrated into a system onboard a vehicle, such as vehicle 101.

As illustrated in FIG. 2, server 210 may receive and analyze data collected by various sources. For example, data may be continuously, regularly, or intermittently captured by sensors 220 (e.g., including sensors 220-A and 220-B) equipped along a road and/or one or more sensors 230 equipped on vehicle 101 driving through lane 104. Sensors 220 and 230 may include radars, LiDARs, cameras (such as surveillance cameras, monocular/binocular cameras, video cameras), speedometers, or any other suitable sensors to capture data characterizing pedestrian 130 and objects surrounding pedestrian 130, such as traffic light 140, pedestrian traffic lights 142, and crosswalk 110. For example, sensors 220 may include one or more surveillance cameras that capture images of pedestrian 130, traffic light 140, pedestrian traffic lights 142, and crosswalk 110.

In some embodiments, sensors 230 may include a LiDAR that measures a distance between vehicle 101 and pedestrian 130, and determines the position of pedestrian 130 in a 3-D map. In some embodiments, sensor 230 may also include a GPS/IMU (inertial measurement unit) sensor to capture position/pose data of vehicle 101. In some embodiments, sensors 230 may additionally include cameras to capture images of pedestrian 130 and objects surrounding pedestrian 130. Since the images captured by sensors 220 and sensors 230 are from different angles, they may supplement each other to provide more detailed information of pedestrian 130 and surrounding objects. In some embodiments, sensors 220 and 230 may acquire data that tracks the trajectories of moving objects, such as vehicles, bicycles, pedestrians, etc.

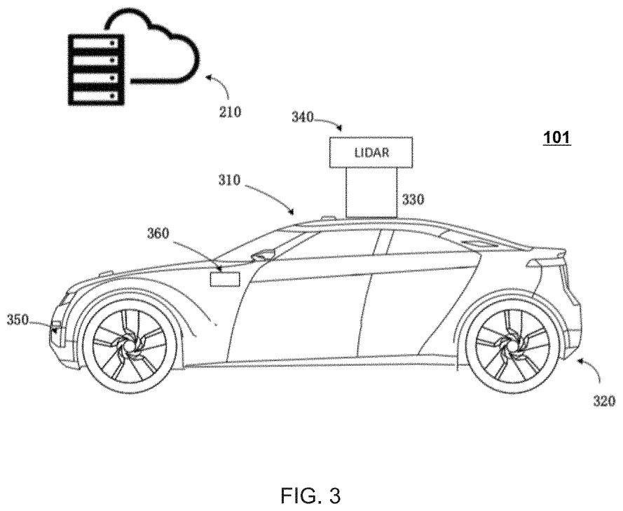

In some embodiments, sensors 230 may be equipped on vehicle 101 and thus travel with vehicle 101. For example, FIG. 3 illustrates an exemplary vehicle 101 with sensors 340-360 equipped thereon, according to embodiments of the disclosure. Vehicle 101 may have a body 310, which may be any body style, such as a sports vehicle, a coupe, a sedan, a pick-up truck, a station wagon, a sports utility vehicle (SUV), a minivan, or a conversion van. In some embodiments, vehicle 101 may include a pair of front wheels and a pair of rear wheels 320, as illustrated in FIG. 3. However, it is contemplated that vehicle 101 may have less wheels or equivalent structures that enable vehicle 101 to move around. Vehicle 101 may be configured to be all wheel drive (AWD), front wheel drive (FWR), or rear wheel drive (RWD). In some embodiments, vehicle 101 may be configured to be an autonomous or semi-autonomous vehicle.

As illustrated in FIG. 3, sensors 230 of FIG. 2 may include various kinds of sensors 340, 350, and 360, according to embodiments of the disclosure. Sensor 340 may be mounted to body 310 via a mounting structure 330. Mounting structure 330 may be an electro-mechanical device installed or otherwise attached to body 310 of vehicle 101. In some embodiments, mounting structure 330 may use screws, adhesives, or another mounting mechanism. Vehicle 101 may be additionally equipped with sensors 350 and 360 inside or outside body 310 using any suitable mounting mechanisms. It is contemplated that the manners in which sensors 340-360 can be equipped on vehicle 101 are not limited by the example shown in FIG. 3 and may be modified depending on the types of sensors 340-360 and/or vehicle 101 to achieve desirable sensing performance.

Consistent with some embodiments, sensor 340 may be a LiDAR that measures the distance to a target by illuminating the target with pulsed laser lights and measuring the reflected pulses. Differences in laser return times and wavelengths can then be used to make digital 3-D representations of the target. For example, sensor 340 may measure the distance between vehicle 101 and pedestrian 130 or other objects. The light used for LiDAR scan may be ultraviolet, visible, or near infrared. Because a narrow laser beam can map physical features with a very high resolution, a LiDAR scanner is particularly suitable for positioning objects in a 3-D map. For example, a LiDAR scanner may capture point cloud data, which may be used to position vehicle 101, pedestrian 130, and/or other objects.

In some embodiments, sensors 350 may include one or more cameras mounted on body 310 of vehicle 101. Although FIG. 3 shows sensors 350 as being mounted at the front of vehicle 101, it is contemplated that sensors 350 may be mounted or installed at other positions of vehicle 101, such as on the sides, behind the mirrors, on the windshields, on the racks, or at the rear end. Sensors 350 may be configured to capture images of objects surrounding vehicle 101, such as pedestrian 130 on the roads, traffic lights (e.g., 140 and 142), crosswalk 110, and/or traffic signs. In some embodiments, the cameras may be monocular or binocular cameras. The binocular cameras may acquire data indicating depths of the objects (i.e., the distances of the objects from the cameras). In some embodiments, the cameras may be video cameras that capture image frames over time, thus recording the movements of the objects.

As illustrated in FIG. 3, vehicle 101 may be additionally equipped with sensor 360, which may include sensors used in a navigation unit, such as a GPS receiver and one or more IMU sensors. A GPS is a global navigation satellite system that provides geolocation and time information to a GPS receiver. An IMU is an electronic device that measures and provides a vehicle's specific force, angular rate, and sometimes the magnetic field surrounding the vehicle, using various inertial sensors, such as accelerometers and gyroscopes, sometimes also magnetometers. By combining the GPS receiver and the IMU sensor, sensor 360 can provide real-time pose information of vehicle 101 as it travels, including the positions and orientations (e.g., Euler angles) of vehicle 101 at each time point.

Consistent with the present disclosure, sensors 340-360 may communicate with server 210 via a network to transmit the sensor data continuously, or regularly, or intermittently. In some embodiments, any suitable network may be used for the communication, such as a Wireless Local Area Network (WLAN), a Wide Area Network (WAN), wireless communication networks using radio waves, a cellular network, a satellite communication network, and/or a local or short-range wireless network (e.g., Bluetooth™).

Referring back to FIG. 2, system 200 may further include a 3-D map database 240. 3-D map database 240 may store 3-D maps. The 3-D maps may include maps that cover different regions and areas. For example, a 3-D map (or map portion) may cover the area of cross-road 100. In some embodiments, server 210 may communicate with 3-D map database 240 to retrieve a relevant 3-D map (or map portion) based on the position of vehicle 101. For example, map data containing the GPS position of vehicle 101 and its surrounding area may be retrieved. In some embodiments, 3-D map database 240 may be an internal component of server 210. For example, the 3-D maps may be stored in a storage of server 210. In some embodiments, 3-D map database 240 may be external of server 210 and the communication between 3-D map database 240 and server 210 may occur via a network, such as the various kinds of networks described above.

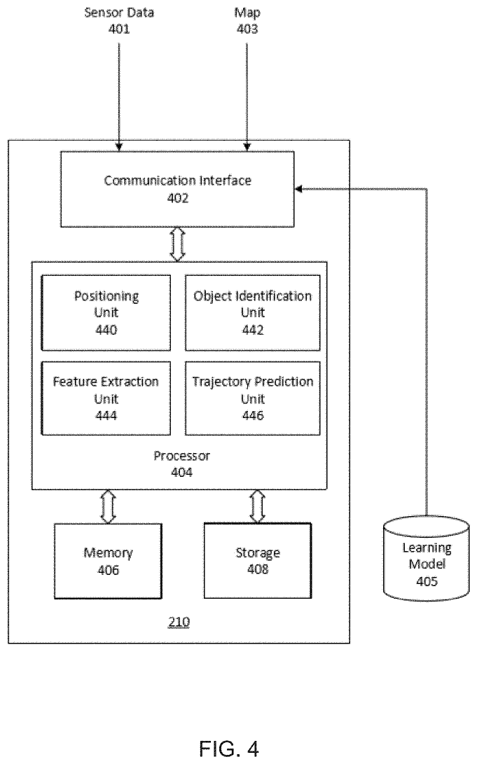

Server 210 may be configured to analyze the sensor data received from sensors 230 (e.g., sensors 340-360) and the map data received from 3-D map database 240 to predict the trajectories of pedestrians, such as pedestrian 130. FIG. 4 is a block diagram of an exemplary server 210 for predicting a pedestrian movement trajectory, according to embodiments of the disclosure. Server 210 may include a communication interface 402, a processor 404, a memory 406, and a storage 408. In some embodiments, server 210 may have different modules in a single device, such as an integrated circuit (IC) chip (implemented as an application-specific integrated circuit (ASIC) or a field-programmable gate array (FPGA)), or separate devices with dedicated functions. Components of server 210 may be in an integrated device, or distributed at different locations but communicate with each other through a network (not shown).

Communication interface 402 may send data to and receive data from components such as sensors 220 and 230 via direct communication links, a Wireless Local Area Network (WLAN), a Wide Area Network (WAN), wireless communication networks using radio waves, a cellular network, and/or a local wireless network (e.g., Bluetooth or WiFi), or other communication methods. In some embodiments, communication interface 402 can be an integrated services digital network (ISDN) card, cable modem, satellite modem, or a modem to provide a data communication connection. As another example, communication interface 402 can be a local area network (LAN) card to provide a data communication connection to a compatible LAN. Wireless links can also be implemented by communication interface 402. In such an implementation, communication interface 402 can send and receive electrical, electromagnetic or optical signals that carry digital data streams representing various types of information via a network.

Consistent with some embodiments, communication interface 402 may receive sensor data 401 acquired by sensors 220 and/or 230, as well as map data 403 provided by 3-D map database 240, and provide the received information to memory 406 and/or storage 408 for storage or to processor 404 for processing. Sensor data 401 may include information capturing pedestrians (such as pedestrian 130) and other objects surrounding the pedestrians. Sensor data 401 may contain data captured over time that characterize the movements of the objects. In some embodiments, map data 403 may include point cloud data.

Communication interface 402 may also receive a learning model 405. In some embodiments, learning model 405 may be applied by processor 404 to predict pedestrian movement trajectories based on features extracted from sensor data 401 and map data 403. In some embodiments, learning model 405 may be a predictive model, such as a decision tree learning model, a logistic regression model, or a convolutional neural network (CNN). Other suitable machine learning models may also be used as learning model 405.

A decision tree uses observations of an item (represented in the branches) to predict a target value of the item (represented in the leaves). For example, a decision tree model may predict the probabilities of several hypothetical outcomes, e.g., probabilities of the candidate trajectories of pedestrian 130. In some embodiments, gradient boosting may be combined with the decision tree learning model to form a prediction model as an ensemble of decision trees. For example, learning model 405 may become a Gradient Boosting Decision Tree model formed with stage-wise decision trees.

In some embodiments, learning model 405 may be a logistic regression model that predicts values of a discrete variable. For example, a logistic regression model may be used to rank several hypothetical outcomes, e.g., to rank the candidate trajectories of pedestrian 130. In some embodiments, learning model 405 may be a convolutional neural network that includes multiple layers, such as one or more convolution layers or fully-convolutional layers, non-linear operator layers, pooling or subsampling layers, fully connected layers, and/or final loss layers. Each layer of the CNN model produces one or more feature maps. A CNN model is usually effective for tasks such as image recognition, video analysis, and image classification to, e.g., identify objects from image or video data.

In some embodiments, learning model 405 may be trained using known pedestrian movement trajectories and their respective sample features, such as semantic features including the pedestrian speed, the orientation of the pedestrian (i.e., the direction the pedestrian is facing), the hand signals of the pedestrian, the markings of the crosswalk, status of the pedestrian traffic light, the type of divider between the sidewalk and the vehicle lane, etc. The sample features may additionally include non-semantic features extracted from data descriptive of the pedestrian movements. In some embodiments, learning model 405 may be trained by server 210 or another computer/server ahead of time.

As used herein, “training” a learning model refers to determining one or more parameters of at least one layer in the learning model. For example, a convolutional layer of a CNN model may include at least one filter or kernel. One or more parameters, such as kernel weights, size, shape, and structure, of the at least one filter may be determined by e.g., a backpropagation-based training process. Learning model 405 is trained such that when it takes the sample features as inputs, it will provide a predicted pedestrian movement trajectory substantially close to the known trajectory.

Processor 404 may include any appropriate type of general-purpose or special-purpose microprocessor, digital signal processor, or microcontroller. Processor 404 may be configured as a separate processor module dedicated to predicting pedestrian movement trajectories. Alternatively, processor 404 may be configured as a shared processor module for performing other functions related to or unrelated to pedestrian trajectory predictions. For example, the shared processor may further make autonomous driving decisions based on the predicted pedestrian movement trajectories.

As shown in FIG. 4, processor 404 may include multiple modules, such as a positioning unit 440, an object identification unit 442, a feature extraction unit 444, a trajectory prediction unit 446, and the like. These modules (and any corresponding sub-modules or sub-units) can be hardware units (e.g., portions of an integrated circuit) of processor 404 designed for use with other components or to execute part of a program. The program may be stored on a computer-readable medium (e.g., memory 406 and/or storage 408), and when executed by processor 404, it may perform one or more functions. Although FIG. 4 shows units 440-446 all within one processor 404, it is contemplated that these units may be distributed among multiple processors located near or remotely with each other.

Positioning unit 440 may be configured to position the pedestrian whose trajectory is being predicted (e.g., pedestrian 130) in map data 403. In some embodiments, sensor data 401 may contain various data captured of the pedestrian to assist the positioning. For example, LiDAR data captured by sensor 340 mounted on vehicle 101 may reveal the position of pedestrian 130 in the point cloud data. In some embodiments, the point cloud data captured of pedestrian 130 may be matched with map data 401 to determine the pedestrian's position. In some embodiments, positioning methods such as simultaneous localization and mapping (SLAM) may be used to position the pedestrian.

In some embodiments, the positions of the pedestrian (e.g., pedestrian 130) may be labeled on map data 401. For example, a subset of point cloud data P₁ is labeled as corresponding to pedestrian 130 at time T₁, a subset of point cloud data P₂ is labeled as corresponding to pedestrian 130 at time T₂, and a subset of point cloud data P₃ is labeled as corresponding to pedestrian 130 at time T₃, etc. The labeled subsets indicate the existing moving trajectory and moving speed of the pedestrian.

Object identification unit 442 may identify pedestrian 130 and objects surrounding the pedestrian. These surrounding objects may include, e.g., traffic light 140, pedestrian traffic lights 142, crosswalk 110, traffic signs, lane markings, divider 108, and other vehicles, etc. In some embodiments, various image processing methods, such as image segmentation, classification, and recognition methods, may be applied to identify the pedestrian and the surrounding objects. In some embodiments, machine learning techniques, such as CNN models, may also be applied for the identification.

Feature extraction unit 444 may be configured to extract features from sensor data 401 and map data 403 that are indicative of a future trajectory of a pedestrian. The features extracted may include pedestrian features and object features. Pedestrian features may be associated with pedestrian 130, e.g., the pedestrian speed, the direction the pedestrian is facing, the locomotion and mobility of the pedestrian, etc. Object features may be associated with the surrounding objects, such as the orientation of the crosswalk, lane markings of sidewalk, the status of the pedestrian traffic light, the pedestrian hand signals, and the type of divider between the sidewalk and the vehicle lane, etc.

Various feature extraction tools may be used, such as facial recognition, gesture detection, movement detection, gait recognition, etc. For example, feature extraction unit 444 may perform facial recognition to identify the pedestrian's face. The pedestrian's face provides important information where the pedestrian is heading to. As another example, feature extraction unit 444 may also perform gesture detection methods to detect the movement of the pedestrian's arm and legs. Pedestrian hand gestures may signal where the pedestrian intends to go. As yet another example, feature extraction unit 444 may gait recognition to extract features indicating how the pedestrian walks, such as body movements, body mechanics, and the activity of the muscles. Such gait features provide information of the pedestrian's locomotion, e.g., the pedestrian is walking, running, jogging, jumping, limping, or moving with assistance. Locomotion of the pedestrian may suggest his mobility. For example, a person walking with the assistance of a cane has a low mobility. In some embodiments, facial features may also help determine the gender and age of the pedestrian, which further help to determine the pedestrian's mobility.

In addition, lane markings and crosswalk markings can be detected from the sensor data based on color and/or contrast information as the markings are usually in white paint and road surface is usually black or gray in color. When color information is available, the markings can be identified based on their distinct color (e.g., white). When grayscale information is available, the markings can be identified based on their different shading (e.g., lighter gray) in contrast to the background (e.g., darker gray for regular road pavements). The orientation of a crosswalk can be determined based on the direction the stipe markings of the crosswalk are extending. As another example, traffic light signals can be detected by detecting the change (e.g., resulting from blinking, flashing, or color changing) in image pixel intensities. In some embodiments, machine learning techniques may also be applied to extract the feature(s).

Features of these surrounding objects may also provide additional information useful to the pedestrian trajectory prediction. For example, if the pedestrian traffic light regulating the pedestrian traffic instructs not to cross, the pedestrian will likely not move immediately. As another example, if the pedestrian is standing on a crosswalk, it is an indication that the pedestrian plans to cross the road.

Trajectory prediction unit 446 may predict the pedestrian movement trajectory using the extracted pedestrian features and object features. In some embodiments, trajectory prediction unit 446 may determine a plurality of candidate trajectories. In some embodiments, the candidate trajectories may be determined based on the direction the pedestrian is facing. For example, if it is detected that pedestrian is facing north, trajectory prediction unit 446 may determine candidate trajectories 151-154 for pedestrian 130 (shown in FIG. 1). That is, pedestrian 130 may cross the road on crosswalk 110 (candidate trajectory 151), turn left into sidewalk 106 (candidate trajectory 152), turn right into sidewalk 106 (candidate trajectory 153), or make a stop (candidate trajectory 154). As another example, if it is detected that pedestrian is facing east, trajectory prediction unit 446 may determine candidate trajectories 161-164 for pedestrian 130 (shown in FIG. 1). That is, pedestrian 130 may go straight along sidewalk 106 (candidate trajectory 161), turn left and cross the road on crosswalk 110 (candidate trajectory 162), turn around and go west-bound on sidewalk 106 (candidate trajectory 163), or make a stop (candidate trajectory 164).

In some embodiments, trajectory prediction unit 446 may apply learning model 405 for the prediction. For example, learning model 405 may determine a score for each candidate trajectory based on the extracted features. In some embodiments, the score may be indicative of a probability that the pedestrian follows the candidate trajectory. In some other embodiments, the score may be a ranking number assigned to the respective trajectory. In some embodiments, the candidate trajectory with the highest score (e.g., highest probability or highest ranking) may be identified as the predicted movement trajectory of the pedestrian.

In some embodiments, before applying learning model 405, trajectory prediction unit 446 may first remove one or more candidate trajectories that conflicts with any of the features. For example, candidate trajectory 163 may be eliminated since the probability that the pedestrian facing east will turn around and go west-bound is substantially low. As another example, if pedestrian traffic light 142-B is in a “do not walk” mode, candidate trajectory 151 may be eliminated. By removing certain candidate trajectories, trajectory prediction unit 446 simplifies the prediction task and conserves processing power of processor 404.

In some embodiments, trajectory prediction unit 446 may compare the determined scores (e.g., probabilities) for the respective candidate trajectories with a threshold. If none of the candidate trajectory has a score exceeding the threshold, trajectory prediction unit 446 may determine that the prediction is not sufficiently reliable and additional “observations” are necessary to improve the prediction. In some embodiments, trajectory prediction unit 446 may determine what additional sensor data can be acquired and generate control signals to be transmitted to sensors 220 and/or 230 for capturing the additional data. For example, it may be determined that the LiDAR should be tilted at a different angle or that the camera should adjust its focal point. The control signal may be provided to sensors 220 and/or 230 via communication interface 402.

In addition to predicting the movement trajectory, trajectory prediction unit 446 may further predict the movement speed of the pedestrian. In some embodiments, the pedestrian's current speed, as well as locomotion and mobility information, may be used to estimate the pedestrian's future movement speed. For example, a running pedestrian will likely cross the road at a fast speed, while one walking with assistance will likely move very slowly.

Memory 406 and storage 408 may include any appropriate type of mass storage provided to store any type of information that processor 404 may need to operate. Memory 406 and storage 408 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 406 and/or storage 408 may be configured to store one or more computer programs that may be executed by processor 404 to perform pedestrian trajectory functions disclosed herein. For example, memory 406 and/or storage 408 may be configured to store program(s) that may be executed by processor 404 to predict the pedestrian movement trajectory based on features extracted from the sensor data 401 captured by various sensors 220 and/or 230, and map data 403.

Memory 406 and/or storage 408 may be further configured to store information and data used by processor 404. For instance, memory 406 and/or storage 408 may be configured to store sensor data 401 captured by sensors 220 and/or 230, map data 403 received from 3-D map database 240, and learning model 405. Memory 406 and/or storage 408 may also be configured to store intermediate data generated by processor 404 during feature extraction and trajectory prediction, such as the pedestrian features and object features, the candidate trajectories, and the scores for the candidate trajectories. The various types of data may be stored permanently, removed periodically, or disregarded immediately after each frame of data is processed.

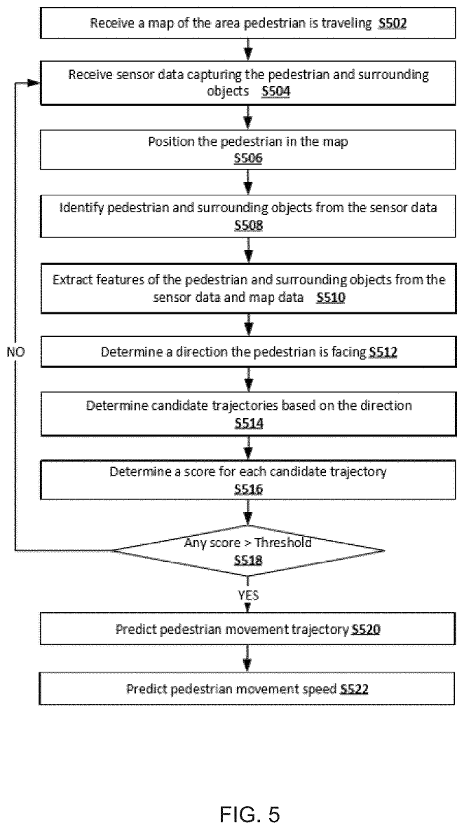

FIG. 5 illustrates a flowchart of an exemplary method 500 for predicting a pedestrian movement trajectory, according to embodiments of the disclosure. For example, method 500 may be implemented by system 200 that includes, among other things, server 210 and sensors 220 and 230. However, method 500 is not limited to that exemplary embodiment. Method 500 may include steps S502-S522 as described below. It is to be appreciated that some of the steps may be optional to perform the disclosure provided herein. Further, some of the steps may be performed simultaneously, or in a different order than shown in FIG. 5. For description purpose, method 500 will be described as predicting the movement trajectory of pedestrian 130 to aid autonomous driving decisions of vehicle 101 (as shown in FIG. 1). Method 500, however, can be implemented for other applications that can benefit from accurate predictions of pedestrian movement trajectories.

In step S502, server 210 receives a map of the area pedestrian 130 is traveling. In some embodiments, server 210 may determine the position of vehicle 101 based on, e.g., the GPS data collected by sensor 360, and identify a map area surrounding the position. Server 210 may receive the relevant 3-D map data, e.g., map data 403, from 3-D map database 240.

In step S504, server 210 receives the sensor data capturing pedestrian 130 and surrounding objects. In some embodiments, the sensor data may be captured by various sensors such as sensors 220 installed along the roads and/or sensors 230 (including, e.g., sensors 340-360) equipped on vehicle 101. The sensor data may include pedestrian speed acquired by a speedometer, images (including video images) acquired by cameras, point cloud data acquired by a LiDAR, etc. In some embodiments, the sensor data may be captured over time to track the movement of pedestrian 130 and surrounding objects. The sensors may communicate with server 210 via a network to transmit the sensor data, e.g., sensor data 401, continuously, or regularly, or intermittently.

Method 500 proceeds to step S506, where server 210 positions pedestrian 130 in the map. In some embodiments, the point cloud data captured of pedestrian 130, e.g., by sensor 340, may be matched with map data 403 to determine the pedestrian's position in the map. In some embodiments, positioning methods such as SLAM may be used to position pedestrian 130. In some embodiments, the positions of pedestrian 130 at different time points may be labeled on map data 403 to trace the prior trajectory and moving speed of the pedestrian. Labeling of the point cloud data may be performed by server 210 automatically or with human assistance.

In step S508, server 210 identifies pedestrian 130 and other objects surrounding pedestrian 130. For example, these objects may include, e.g., traffic light 140, pedestrian traffic lights 142, crosswalk 110, sidewalk 106, divider 108, traffic signs, and lane markings, etc. Features of the pedestrian and surrounding objects may provide information useful for predicting the movement trajectory of pedestrian 130. In some embodiments, various image processing methods and machine learning methods (e.g., CNN) may be implemented to identify the pedestrian and surrounding objects.

In step S510, server 210 extracts pedestrian features of pedestrian 130 and object features of surrounding objects from sensor data 401 and map data 403. In some embodiments, the features extracted may include semantical or non-semantical that are indicative of the future trajectory of the pedestrian. For example, pedestrian features may include, e.g., the pedestrian speed, and the direction the pedestrian is facing, the locomotion and mobility of the pedestrian, any hand signals of the pedestrian, etc. Object features of surrounding objects may include, e.g., the lane markings of sidewalk, stripe markings and orientation of the crosswalk, the status of the pedestrian traffic lights, the type of divider between the sidewalk and the vehicle lane, and information on the traffic signs. In some embodiments, various feature extraction methods including image processing methods and machine learning methods may be implemented.

In step S512, server 210 determines a direction pedestrian 130 is facing. For example, facial recognition may be performed to identify the face of pedestrian and the direction it is facing. In step S514, server 210 determines multiple candidate trajectories for pedestrian 130 based on the direction he is facing. Candidate trajectories are possible trajectories pedestrian 130 may follow. For example, pedestrian 130 facing north may follow one of the four candidate trajectories 151-154 (shown in FIG. 1), i.e., to cross road segment 100 north-bound, turn left into sidewalk 106, turn right into sidewalk 106, or make a stop. Similarly, pedestrian 130 facing east may follow one of the four candidate trajectories 161-164, i.e., to continue east-bound on sidewalk 106, turn left to cross the road on crosswalk 110, turn around and walk west-bound on sidewalk 106, or make a stop.

In some embodiments, server 210 may remove one or more candidate trajectories that conflict with any of the features. For example, for pedestrian 130 who faces east, candidate trajectory 163 may be eliminated since the probably that the pedestrian will turn around and go west-bound is substantially low. This optional filtering step may help simplify the prediction task and conserve processing power of server 210.

Method 500 proceeds to step S516 to determine a score for each candidate trajectory. In some embodiments, the score may be a probability the pedestrian will follow the respective candidate trajectory or a ranking number assigned to the candidate trajectory. In some embodiments, server 210 may apply learning model 405 for the prediction. In some embodiments, learning model 405 may be a predictive model, such as a decision tree learning model, a logistic regression model, or a CNN model. For example, learning model 405 may be a Gradient Boosting Decision Tree model. In some embodiments, learning model 405 may be trained using known pedestrian movement trajectories and their respective sample features.

For example, in step S516, learning model 405 may be applied to determine a probability for each candidate trajectory based on the extracted pedestrian features and object features. For example, it may be determined that pedestrian 130 has a 60% probability to follow candidate trajectory 151, 20% probability to follow candidate trajectory 152, 5% probability to follow candidate trajectory 153, and 15% probability to follow candidate trajectory 154.

In step S518, server 210 may compare the scores (e.g., probabilities) with a predetermined threshold. In some embodiments, the predetermined threshold may be a percentage higher than 50%, such as 60%, 70%, 80%, or 90%. If no probability is higher than the threshold (S516: No), the prediction may be considered unreliable. In some embodiments, method 500 may return to step S504 to receive additional sensor data to improve the prediction. In some embodiments, server 210 may determine what additional sensor data can be acquired and generate control signals to direct sensors 220 and/or 230 to capture the additional data to be received in step S504.

If at least the highest score is higher than the threshold (S518: Yes), server 210 may predict the pedestrian movement trajectory in step S520 by selecting the corresponding candidate trajectory from the candidate trajectories. In some embodiments, the candidate trajectory with the highest probability may be identified as the predicted trajectory of the pedestrian. For example, candidate trajectory 152 may be selected as the predicted trajectory of pedestrian 130 when it has the highest probability. In some other embodiments, when in step S518 sever 210 ranks the candidate trajectories rather than calculating the probabilities, method 500 may skip step S518 and select the candidate trajectory with the highest ranking in step S520.

In step S522, server 210 further predicts the movement speed of the pedestrian. In some embodiments, the pedestrian's current speed, as well as locomotion and mobility information, may be used to estimate the pedestrian's future movement speed. For example, a running pedestrian will likely cross the road at a fast speed, while one walking with assistance will likely move very slowly.

The prediction result provided by method 500 may be provided to vehicle 101, and used to aid vehicle controls or driver's driving decisions. For example, an autonomous vehicle may make automated control decisions based on the predicted trajectories of pedestrians in order not to run over them. The prediction may also be used to help alert a driver to adjust his intended driving path and/or speed to avoid an accident. For example, audio alerts such as beeping may be provided to warn the driver and/or pedestrians.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A system for predicting a movement trajectory of a pedestrian, comprising:
a communication interface configured to receive a map of an area in which the pedestrian is traveling and sensor data acquired associated with the pedestrian; and
at least one processor configured to:
position the pedestrian in the map;
extract pedestrian features from the sensor data;
identify one or more objects surrounding the pedestrian based on the positioning of the pedestrian;
extract object features of the one or more objects from the sensor data; and
predict the movement trajectory and a movement speed of the pedestrian based on the extracted pedestrian features and object features using a learning model.

2. The system of claim 1, wherein to predict the movement trajectory of the pedestrian, the at least one processor is further configured to:
determine a plurality of candidate trajectories;
determine a score for each candidate trajectory based on the extracted pedestrian features and object features using the learning model; and
identify the candidate trajectory with the highest score as the predicted movement trajectory of the pedestrian.

3. The system of claim 2, wherein the at least one processor is further configured to:
determine a direction the pedestrian is facing based on the sensor data; and
determine the plurality of candidate trajectories based on the direction.

4. The system of claim 2, wherein the score is a probability the pedestrian will follow the corresponding candidate trajectory.

5. The system of claim 1, wherein the learning model is a decision tree model, a logistic regression model, or a convolutional neural network.

6. The system of claim 1, wherein the sensor data includes point cloud data acquired by a LiDAR and images acquired by a camera.

7. The system of claim 1, wherein to extract pedestrian features, the at least one processor is further configured to detect a locomotion of the pedestrian.

8. The system of claim 1, wherein to extract pedestrian features, the at least one processor is further configured to detect a mobility of the pedestrian.

9. The system of claim 1, wherein to extract pedestrian features, the at least one processor is further configured to a prior movement trajectory of the pedestrian.

10. The system of claim 1, wherein the one or more objects include a pedestrian traffic light that the pedestrian is facing, wherein to extract object features, the at least one processor is further configured to determine a status of the pedestrian traffic light.

11. The system of claim 1, wherein the one or more objects include a crosswalk that the pedestrian is following, wherein to extract object features of the one or more objects, the at least one processor is further configured to detect an orientation of the crosswalk.

12. The system of claim 1, wherein the sensor data are acquired by at least one sensor equipped on a vehicle traveling in the area that the pedestrian is traveling in, wherein the communication interface is further configured to provide the predicted movement trajectory and movement speed of the pedestrian to the vehicle.

13. A method for predicting a movement trajectory of a pedestrian, comprising:
receiving, by a communication interface, a map of an area in which the pedestrian is traveling and sensor data acquired associated with the pedestrian;
positioning, by at least one processor, the pedestrian in the map;
extracting, by the at least one processor, pedestrian features from the sensor data;
identifying, by the at least one processor, one or more objects surrounding the pedestrian based on the positioning of the pedestrian;
extracting, by the at least one processor, object features of the one or more objects from the sensor data; and
predicting, by the at least one processor, the movement trajectory and a movement speed of the pedestrian based on the extracted pedestrian features and object features using a learning model.

14. The method of claim 13, wherein predicting the movement trajectory of the pedestrian further comprises:
determining a plurality of candidate trajectories;
determining a score for each candidate trajectory based on the extracted pedestrian features and object features using the learning model; and
identifying the candidate trajectory with the highest score as the predicted movement trajectory of the pedestrian.

15. The method of claim 13, wherein the learning model is a decision tree model, a logistic regression model, or a convolutional neural network.

16. The method of claim 13, wherein extracting pedestrian features further comprises:
determining a direction the pedestrian is facing;
detecting a locomotion of the pedestrian;
detecting a mobility of the pedestrian; and
determining a prior movement trajectory of the pedestrian.

17. The method of claim 13, wherein extracting object features further comprises:
determining a status of a pedestrian traffic light that the pedestrian is facing; and
detecting an orientation of a crosswalk that the pedestrian is following.

18. The method of claim 13, wherein the sensor data are acquired by at least one sensor equipped on a vehicle traveling in the area that the pedestrian is traveling in, wherein the method further comprises providing the predicted movement trajectory and movement speed of the pedestrian to the vehicle.

19. A non-transitory computer-readable medium having instructions stored thereon that, when executed by at least one processor, causes the at least one processor to perform operations comprising:
receiving a map of an area in which the pedestrian is traveling and sensor data acquired associated with the pedestrian;
positioning the pedestrian in the map;
extracting pedestrian features from the sensor data;
identifying one or more objects surrounding the pedestrian based on the positioning of the pedestrian;
extracting object features of the one or more objects from the sensor data; and
predicting the movement trajectory and a movement speed of the pedestrian based on the extracted pedestrian features and object features using a learning model.

20. The computer-readable medium of claim 19, wherein predicting the movement trajectory of the pedestrian further comprises:
determining a plurality of candidate trajectories;
determining a score for each candidate trajectory based on the extracted pedestrian features and object features using the learning model; and
identifying the candidate trajectory with the highest score as the predicted movement trajectory of the pedestrian.
